(19) United States
(12) Patent Application Publication
(10) Pub. No.: US 2015/0213470 A1
(43) Pub. Date: Jul. 30, 2015

(54) Competitive Pricing Template

(71) Applicant: Bank of America Corporation, Charlotte, NC (US)

(72) Inventors: James E. Rush, Charlotte, NC (US); Matthew Fragale, Matthews, NC (US); Andrew McGowan, Charlotte, NC (US); Joan O'Donoghue, Charlotte, NC (US); William Terrell, Lawrenceville, GA (US)

(21) Appl. No.: 14/476,253

(22) Filed: Sep. 3, 2014

Related U.S. Application Data
(60) Provisional application No. 61/932,594, filed on Jan. 28, 2014.

(51) Int. Cl. G06Q 30/02; G06Q 50/18

(52) U.S. Cl. CPC G06Q 30/0206; G06Q 50/188

(57) ABSTRACT

Systems and methods for competitive pricing analysis are provided. An interactive pricing analysis template may be presented to at a user at a display device, and information describing a negotiated deal involving the purchase of a set of components may be received at the template from the user. The template may be presented to another user at another display device, and a standard pricing metric and best-in-class offer may be received from that user for each component. A component score may be automatically calculated for each component based, at least in part, on the best-in-class offer and a pricing analysis framework. A composite score for the negotiated deal may also be automatically calculated based, at least in part, on the pricing analysis framework. The template may include, for each component, input elements that respectively receive the standard pricing metric, the best-in-class offer, a proposed offer, and a quantity.

### CROSS-REFERENCE TO RELATED APPLICATIONS

This application claims the benefit of U.S. Provisional Patent Application No. 61/932,594 entitled “Competitive Pricing Framework” and filed on Jan. 28, 2014 which is incorporated by reference in its entirety herein.

This application is also related to U.S. patent application Ser. No. 14/230,746 entitled “Competitive Pricing Framework” and filed on Mar. 31, 2014 which is also incorporated by reference in its entirety herein.

### BACKGROUND

Enterprises and other entities often negotiate deals with vendors such as technology vendors to purchase various products and services. During negotiations such entities attempt to reach the best deal possible. Having negotiated the deal such entities often seek to assess the value of the negotiated deal. To assess the value of the negotiated deal, an entity may compare the negotiated deal to previous deals it has negotiated with vendors. This analysis, however, may only provide a limited view of the negotiated deal relative to previous deals as the entity may only have access to information about previous deal the entity itself has negotiated.

An entity may desire to enhance its analysis of the negotiated deal by comparing it to deals that other entities have negotiated. An entity may lack access to information describing deals other entities have negotiated however. Furthermore entities may be reluctant to share information about the deals each has negotiated where, for example, the entities are competitors.

Therefore a need exists for facilitating competitive pricing analysis of negotiated deals.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

A first aspect of the present disclosure provides a system for competitive pricing analysis. The system includes a display device, a processing unit in signal communication with the display device, and memory in signal communication with the processing unit that stores computer-readable instructions. When executed at the processing unit, the instructions cause the system to perform steps for performing a competitive pricing analysis. An interactive pricing analysis template is displayed at the display device, and information describing a negotiated deal for the purchase of a set of components is received at the template. For each component, a component score is calculated based, at least in part, on a best-in-class offer and a pricing analysis framework. A composite score for the negotiated deal may also be calculated based, at least in part, on the pricing analysis framework. The template may include, for each component, input elements that respectively receive a standard pricing metric, a best-in-class offer, a proposed offer, and a quantity.

A second aspect of the present disclosure provides a computer-implemented method for competitive pricing analysis. An interactive pricing analysis template may be presented to at a user at a display device, and information describing a negotiated deal involving the purchase of a set of components may be received from the user at the template. The interactive pricing analysis template may be presented to another user at another display device, and a standard pricing metric and a best-in-class offer may be received from that user for each component in the set of components. A component score may be automatically calculated for each component in the set of components based, at least in part on the best-in-class offer and a pricing analysis framework. A composite score for the negotiated deal may also be automatically calculated for the negotiated deal based, at least in part, on the pricing analysis framework. The template may include, for each component, input elements that respectively receive a standard pricing metric, a best-in-class offer, a proposed offer, and a quantity.

The details of these and other embodiments of the disclosure are set forth in the accompanying drawings and description below. Other features and advantages of aspects of the disclosure will be apparent from the description, drawings, and claims.

### BRIEF DESCRIPTION OF THE DRAWINGS

Aspects of the disclosure may be implemented in certain parts, steps, and embodiments that will be described in detail in the following description and illustrated in the accompanying drawings in which like reference numerals indicate similar elements. It will be appreciated with the benefit of this disclosure that the steps illustrated in the accompanying figures may be performed in other than the recited order and that one or more of the steps disclosed may be optional. It will also be appreciated with the benefit of this disclosure that one or more components illustrated in the accompanying figures may be positioned in other than the disclosed arrangement and that one or more of the components illustrated may be optional.

FIG. 1 is an illustrative operating environment in which various aspects of the disclosure may be implemented.

FIG. 2 is a block diagram of an example of an implementation of a competitive pricing analysis system.

FIG. 3 is a block diagram of a detailed view of an example of an implementation of a competitive pricing analysis system is shown.

FIG. 4 is a flowchart of example method steps for performing a competitive pricing analysis.

FIG. 5 is an example of an implementation of an interactive pricing analysis template.

FIG. 6A is an example of an implementation of a proposed offer section of an interactive pricing analysis template.

FIG. 6B is another example of an implementation of a proposed offer section of an interactive pricing analysis template.

FIG. 7A is an example of an implantation of a component information section of an interactive pricing analysis template.

FIG. 7B is another example of an implementation of a component information section of an interactive pricing analysis template.

FIG. 8A is an example of an implementation of a pricing analysis framework section of an interactive pricing analysis template.

FIG. 8B is another example of an implementation of a pricing analysis framework section of an interactive pricing analysis template.

FIG. 9 is an example of an implementation of a peer group information section of an interactive pricing analysis template.

FIG. 10 is an example of an implementation of a pricing summary interface of an interactive pricing analysis template.

FIG. 11 is an example of an implementation of an executive summary interface of an interactive pricing analysis template.

### DETAILED DESCRIPTION

In accordance with various aspects of the disclosure, methods, non-transitory computer-readable media, and apparatuses are disclosed for facilitating competitive pricing analyses of negotiated deals involving the purchase of products or services. A competitive pricing analysis system manages the transmission of an interactive pricing analysis template between the computing system of a party to the negotiated deal and the computing system of an analysis firm that performs a competitive pricing analysis of the deal. The party to the negotiated deal making the purchase of the products or services may be referred to as the buyer.

The interactive pricing analysis template standardizes the manner in which a buyer describes a negotiated deal for the analysis firm. The interactive pricing analysis template also standardizes the manner in which the analysis firm describes the result of its analysis of the negotiated deal. The interactive pricing analysis template also includes a pricing analysis framework that it uses to automatically score the negotiated deal as well as individual elements of the negotiated deal. The interactive pricing analysis template also automatically creates various interfaces to summarize the details of the negotiated deal as well as the results of the competitive pricing analysis of the negotiated deal.

While many options are available for enhancing the analysis of negotiated deals, the aspects of the present disclosure provide particular advantages and improvements to the field of competitive pricing analysis. The standardizations and automations that the pricing analysis template provides allow a buyer to more quickly and efficiently describe the aspects of a negotiated deal. The standardizations and automations that the pricing analysis template provides likewise allow an analysis firm to more quickly and efficiently provide the information used to score the deal and its individual elements. The pricing analysis template also advantageously decreases the turnaround time for completing a competitive pricing analysis than otherwise might be possible employing some current approaches. Additional advantages and efficiencies provided by the competitive pricing analysis will be appreciated with the benefit of the additional details described below.

It is also to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging. In addition, “set” as used in this description refers to a collection that may include one element or more than one element.

Moreover, aspects of the disclosure may be implemented in non-transitory computer-readable media having instructions stored thereon that, when executed by a processor, cause the processor to perform various steps described in further detail below. As used in this description, non-transitory computer-readable media refers to all computer-readable media with the sole exception being a transitory propagating signal. The instructions may be organized into one or more program modules that may be executed by one or more computers or other devices as described herein. Program modules may include routines, programs, objects, components, data structures, and the like that perform particular tasks or implement particular data types when executed by a processor in a computer or other device. The modules may be written in a source code programming language that is subsequently compiled for execution, or may be written in a scripting language that supports scripts interpreted in a run-time environment. The instructions may be stored on a computer-readable medium as described in further detail below. Accordingly aspects of the disclosure may be embodied as a method, data processing system, or computer program product. Functionality described below may therefore be embodied at least in part in software, firmware, or hardware such as integrated circuits, field programmable gate arrays (FPGA), and the like. Furthermore data structures that implement aspects of the disclosure are considered to be within the scope of the computer-readable instructions.

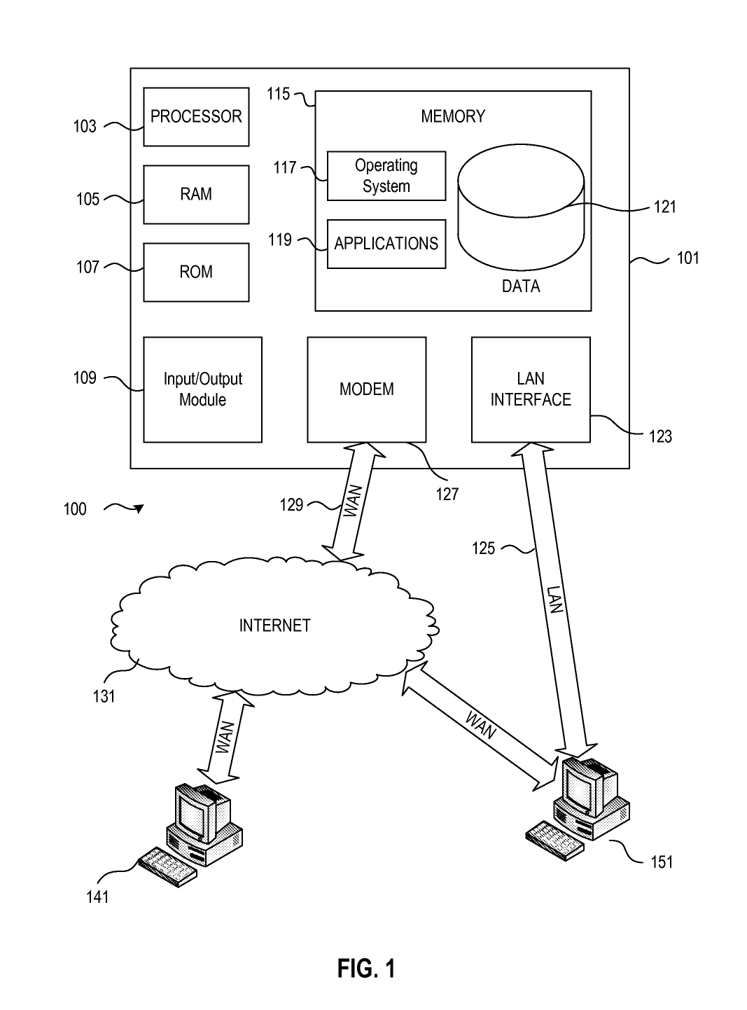

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational within a special purpose computing systems and environments configured to facilitate competitive pricing analyses. These special purpose computing systems and environments may include personal computers (PCs), server computers, hand-held or laptop devices, multiprocessor systems, microprocessor-based systems, programmable consumer electronics, network PCs, minicomputers, mainframe computers, distributed computing environments that include any of the systems or devices listed above, and the like.

With reference to FIG. 1, the computing system environment 100 may include a competitive pricing analysis server 101 at which aspects of the disclosure may be implemented. The competitive pricing analysis server 101 may have a processor 103 for controlling the its overall operation and its associated components which may include random-access memory (RAM) 105, read-only memory (ROM) 107, a communications module 109, and memory 115. The processor 103 and its associated components may allow the competitive pricing analysis server 101 to run a series of computer-readable instructions related to facilitating competitive pricing analyses.

The competitive pricing analysis server 101 may include a variety of computer-readable media. The computer-readable media may be any available non-transitory media that may be accessed by the competitive pricing analysis server 101 and may include both volatile and non-volatile media as well as removable and non-removable media.

Computer storage media include volatile and non-volatile, removable and non-removable media implemented in any method or technology for storage of information such as computer-readable instructions, data structures, program modules, or other data. Computer storage media include, but are not limited to, random access memory (RAM), read-only memory (ROM), electronically erasable programmable read only memory (EEPROM), flash memory or other memory technology, CD-ROM discs, digital versatile discs (DVD), or other optical disk storage, magnetic cassettes, magnetic tape, magnetic disk storage or other magnetic storage devices, or any other non-transitory medium that can be used to store the desired information that can be accessed by the competitive pricing analysis server 101.

The computing system environment 100 may also include optical scanners (not shown). Example uses of the optical scanners include scanning and converting paper documents, such as correspondence, data, and the like to digital files.

Although not shown, RAM 105 may include one or more applications representing the application data stored in RAM 105 while the competitive pricing analysis server 101 is running and while corresponding software applications (e.g., software tasks) are executing on the competitive pricing analysis server 101.

The communications module 109 may include a microphone, keypad, touch screen, stylus, or other types of input devices through which a user of the competitive pricing analysis server 101 may provide input, and may also include one or more of a speaker for providing audio output and a video display device for providing textual, audiovisual, and/or graphical output.

Software may be stored within memory 115 and/or a storage device or storage media to provide instructions to the processor 103 that enable the competitive pricing analysis server 101 to perform various functions. For example, memory 115 may store software used by the competitive pricing analysis server 101, such as an operating system 117, application programs 119, and an associated database 121. In certain aspects, the competitive pricing analysis server 101 may comprise a plurality of databases 121. Also, some or all of the computer executable instructions for the competitive pricing analysis server 101 may be embodied in hardware or firmware.

The competitive pricing analysis server 101 may operate in a networked environment supporting connections to one or more remote computing devices, such as computing devices 141 and 151. The computing devices 141 and 151 may be personal computing devices or servers that include many or all of the elements described above relative to the competitive pricing analysis server 101.

The network connections depicted in FIG. 1 may include a local area network (LAN) 125 and a wide area network (WAN) 129, but may also include other types of networks. When used in a LAN networking environment, the competitive pricing analysis server 101 may be connected to the LAN 125 through a network interface or adapter in the communications module 109. When used in a WAN networking environment, the competitive pricing analysis server 101 may include a modem in the communications module 109 or other means for establishing communications over the WAN 129, which may include the Internet 131 or other type of wide-area computer network. It will be appreciated that the network connections shown are illustrative and other means of establishing a communications link between the computing devices may be used. Various well-known protocols such as TCP/IP, Ethernet, FTP, HTTP, and the like may be used. The competitive pricing analysis server 101 may be operated in a client-server configuration to permit a user to retrieve web pages from a web-based server. Any of various conventional web browsers may be used to display and manipulate web pages.

Additionally, one or more application programs 119 used by the competitive pricing analysis server 101, according to an illustrative embodiment, may include computer-executable instructions for invoking functionality related to communication including, for example, email, short message service (SMS), and voice input and speech recognition applications. In addition, the application programs 119 may include computer-executable instructions for invoking user functionality related to access a centralized repository for performing various service tasks like routing, logging, data storage, and protocol bridging.

Embodiments of the disclosure may include forms of computer-readable media. Computer-readable media include any non-transitory media that can be accessed by the competitive pricing analysis server 101. Storage media include volatile and nonvolatile, removable and non-removable media implemented in any method or technology for storage of information such as computer-readable instructions, object code, data structures, program modules, or other data.

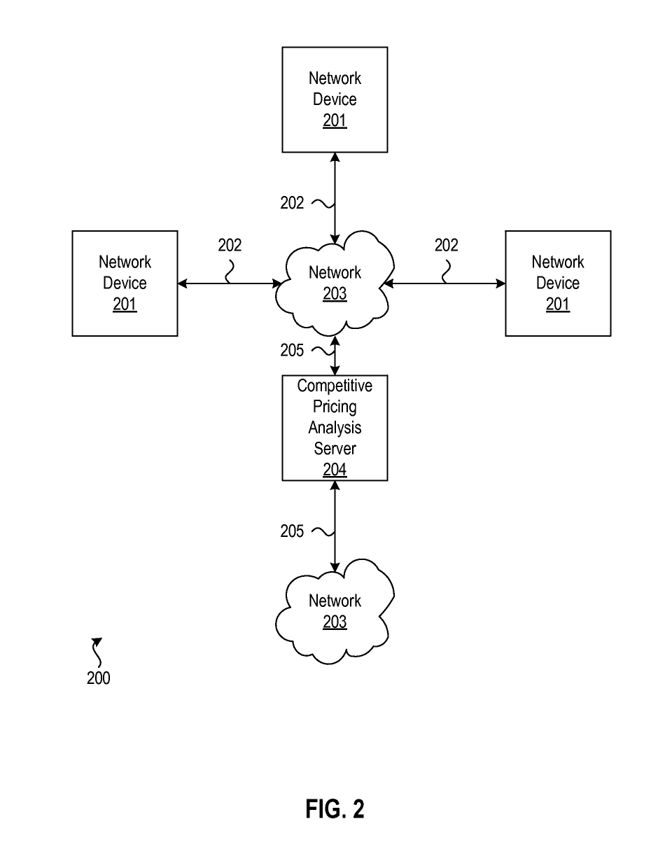

Referring now to FIG. 2, a block diagram of an example of an implementation of a competitive pricing analysis system 200 is shown. As illustrated, the competitive pricing analysis system 200 may include one or more network devices 201 which may, in some examples, be connected by one or more communications links 202 to computer network 203. The computer network 203 may in turn be linked via communications links 205 to the competitive pricing analysis server 204. In the competitive pricing analysis system 200, the competitive pricing analysis server 204 may be any suitable server, processor, computer, or data processing device, or combination of the same. In some example implementations the competitive pricing analysis server 204 of FIG. 2 may be the same as or at least similar to the competitive pricing analysis server 101 described above with reference to FIG. 1. The competitive pricing analysis server 204 may be used to process input received from a user or one or more of the network devices 201.

According to one or more aspects, the competitive pricing analysis system 200 may be associated with the buyer that has negotiated a deal. Various elements of the competitive pricing analysis system 200 may be located at facilities associated with the buyer or may be located remotely from such facilities. Some elements of the competitive pricing analysis system may be located at facilities associated with the competitive pricing analysis firm. For instance, one or more of the network devices 201 may be located within a branch office of the buyer while one or more other network devices may be located within an office of the competitive pricing analysis firm. The network devices 201 may be used, for example, by users associated with the buyer as well as by users associated with the competitive pricing analysis firm. In some example implementations, the competitive pricing analysis server 204 may be located at a facility associated with the buyer while in other example implementations the competitive pricing analysis server 204 may be located at a facility associated with the competitive pricing analysis firm. In some instances, the buyer may be, for example, a financial institution such as a bank. Although it will be appreciated that the buyer may be one of many other types of entities that negotiate deals for the purchase of products and services.

The computer network 203 may be any suitable computer network including the Internet, an intranet, a wide-area network (WAN), a local-area network (LAN), a wireless network, a digital subscriber line (DSL) network, a frame relay network, and asynchronous transfer mode network, a virtual private network (VPN), or any combination of any of the same. The communications links 202 and 205 may be any communications links suitable for communicating between the network devices 201 and the competitive pricing analysis server 204, such as network links, dial-up links, wireless links, hard-wired links, and the like.

Having described examples of computing devices that may be used to implement various aspects of the disclosure and an operating environment in which various aspects of the disclosure may be implemented, various embodiments are discussed in greater detail below.

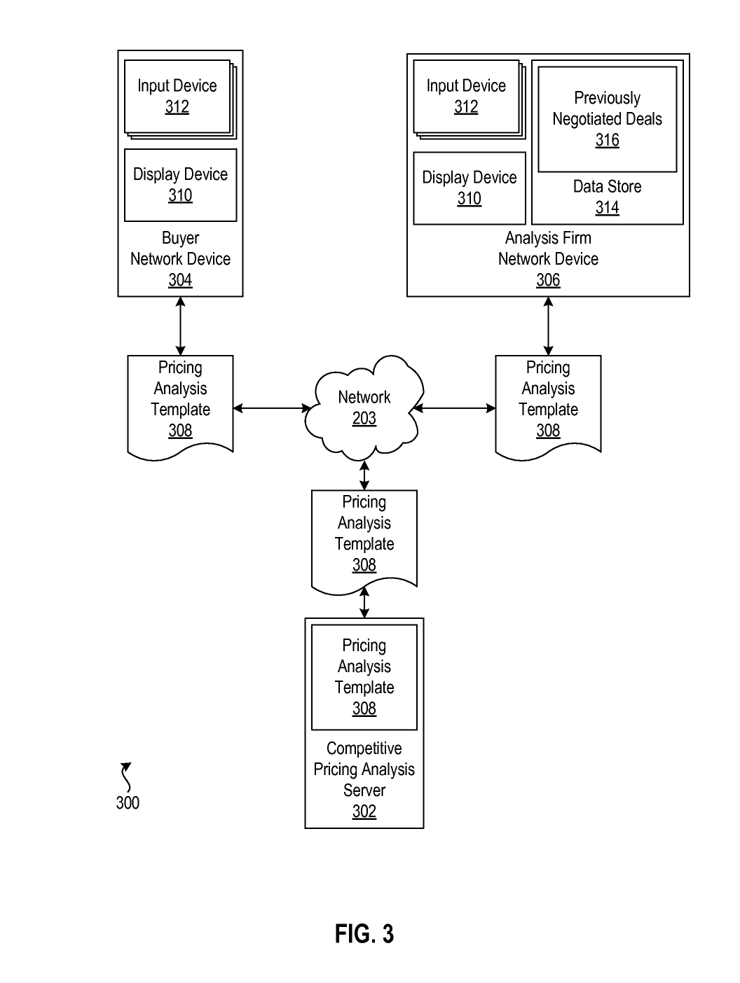

In FIG. 3, a block diagram of a detailed view of a competitive pricing analysis system 300 is shown. The competitive pricing analysis system 300 may be similar to the competitive pricing analysis system 200 of FIG. 2. The competitive pricing analysis system 300 may similarly include a competitive pricing analysis server 302, which may be the same as or at least similar to the competitive pricing analysis server 204 of FIG. 2 and the competitive pricing analysis server 101 of FIG. 1. The competitive pricing analysis server 302 may be in signal communication via a network 203 with a network device 304 of a buyer that has negotiated a deal and a network device 306 of an analysis firm that performs the competitive pricing analysis of the negotiated deal. The network device 304 of the buyer and the network device 306 of the analysis firm may be the same as or at least similar to the network devices 201 of FIG. 2.

The competitive pricing analysis server 302 may include an interactive pricing analysis template 308 (“interactive pricing analysis template”). The competitive pricing analysis server 302 may facilitate access to the interactive pricing analysis template 308 from each of the buyer network device 304 and the analysis firm network device 306. For instance, the competitive pricing analysis server 302 may manage the distribution of the interactive pricing analysis template 308 to the buyer network device 304 and the analysis firm network device 306 across the network 203. Other ways in which the competitive pricing analysis server 302 may facilitate access to the interactive pricing analysis template will be appreciated with the benefit of this disclosure.

The network device 304 of the buyer and the network device of the analysis firm may each include a display device 310 and various input devices 312 such as a keyboard and a mouse. The display device 310 may present the interactive pricing analysis template 308 to a user, and the user may interact with the template using the input devices 312. As described in further detail below, the buyer may interact with the interactive pricing analysis template 308 to provide information describing the negotiated deal. The competitive pricing analysis firm may in turn access the interactive pricing analysis template 308 to provide the results of its competitive pricing analysis. The network device 306 of the competitive pricing analysis firm may include a data store 314 that stores records 316 associated with previously negotiated deals. The previously negotiated deals may be deals that other buyers have negotiated. The competitive pricing analysis firm may collect and store information associated with negotiated deals and then leverage that information during a competitive pricing analysis to assess the value of the current deal the buyer has negotiated, e.g., whether the buyer has negotiated a better deal than previous deals negotiated by other buyers. In this way, the buyer may advantageously assess the value of the deal it has negotiated based on more than the deals it has previously negotiated itself, but rather on deals previously negotiated by other entities across a variety of industries. In this way, the buyer advantageously obtains a much broader understanding of whether or not it has negotiated a relatively better deal.

Whether a negotiated deal is determined to be a better deal than previously negotiated deals may depend on how the offer proposed in the negotiated deal compares to a best-in-class offer that is determined by the competitive pricing analysis firm based on one or more previously negotiated deals. If the proposed offer of a negotiated deal is relatively lower than the best-in-class offer, for example, then the negotiated deal may be determined to be a relatively better deal than previously negotiated deals. If, however, the proposed offer of the negotiated deal is relatively higher than the best-in-class offer, then the previously negotiated deals may be determined to be relatively better.

The interactive pricing analysis template 308 may be implemented in a variety of ways. In one example implementation the interactive pricing analysis template 308 may be an electronic file having a set of interfaces with respective input elements that receive input from users that describe the negotiated deal and the results of the competitive pricing analysis. The competitive pricing analysis server 302 may facilitate access to the interactive pricing analysis template 308, in this example, by transmitting via the network 203 the interactive pricing analysis template 308 to the buyer network device 304 and to the analysis firm network device 306. A user associated with the buyer, in this example, may update portions of the interactive pricing analysis template 308 directed toward the details of the negotiated deal and transmit the updated template back to the competitive pricing analysis server 302. The competitive pricing analysis server 302 may in turn transmit the updated interactive pricing analysis template 308 to the analysis firm network device 306. A user associated with the analysis firm, in this example, may likewise update the portions of the interactive pricing analysis template 308 directed toward the results of the competitive pricing analysis and transmit the completed template back to the competitive pricing analysis server 302. The competitive pricing analysis server 302 may then transmit the completed interactive pricing analysis template 308 to the buyer network device 304 for review by the buyer.

In another example implementation, the interactive pricing analysis template 308 may be implemented as a web application running at the competitive pricing analysis server 302 that is accessible via a website address such as a URL (Uniform Resource Locator). In this alternative implementation, the web application may include a set of web pages served to the buyer network device 304 and the analysis firm network device 306. The web pages may similarly include respective input elements that receive input from users that describe the negotiated deal and the results of the competitive pricing analysis. A user associated with the buyer may, for example, access the web application to create a new record of a negotiated deal and provide input directed toward the details of the negotiated deal. The competitive pricing analysis server 302 may then notify the analysis firm (e.g., via email) that the buyer has submitted a new negotiated deal for analysis. A user associated with the analysis firm may then access the web application and provide input directed toward the results of the competitive pricing analysis. The negotiated deal may be associated with a unique identifier (such as a serial number or customer number), and the user at the analysis firm may navigate to the negotiated deal at the web application using this unique identifier. The competitive pricing analysis server 302 may provide the unique identifier to the analysis firm in the initial notification. Once the analysis firm has completed the interactive pricing analysis template, the competitive pricing analysis server 302 may notify the buyer that the results of the competitive pricing analysis are ready for review. The competitive pricing analysis server 302 may store information associated with the negotiated deal and its competitive pricing analysis in one or more records of a data store such as database 121 of FIG. 1.

Additional and alternative implementations of the interactive pricing analysis template will be appreciated by those skilled in the art with the benefit of this disclosure. For example the interactive pricing analysis template may be implemented using one or more of a desktop application, a mobile application, and the like.

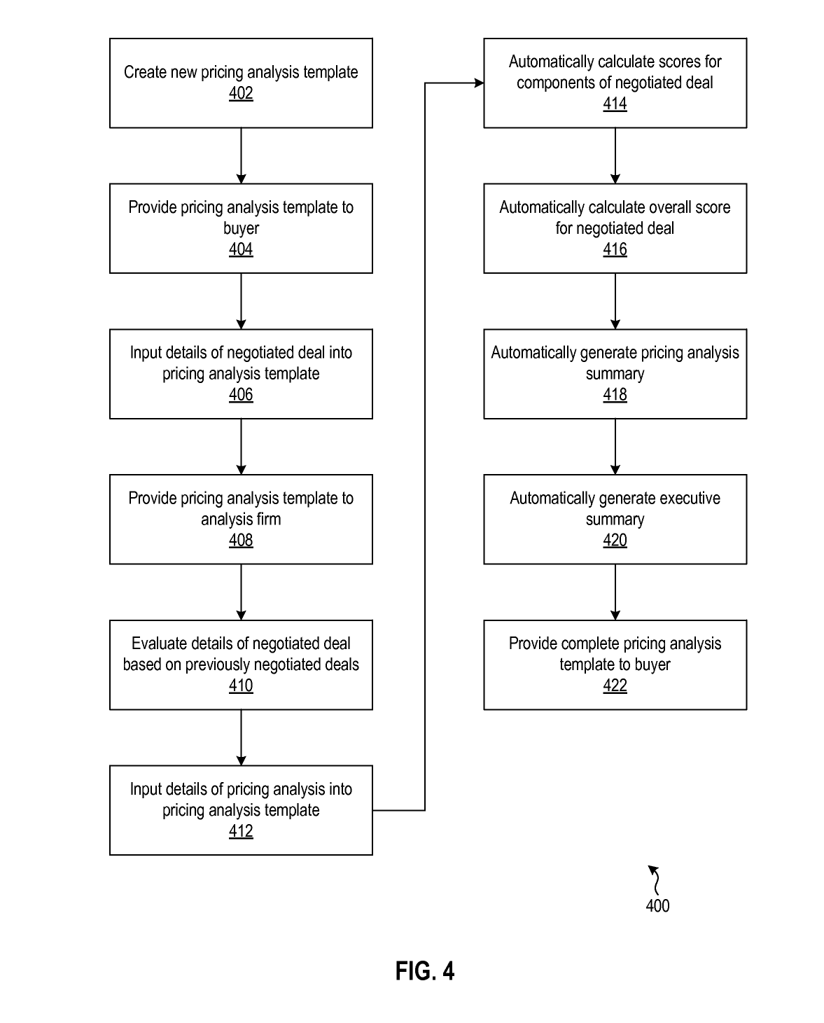

Referring now to FIG. 4, a flowchart 400 of example method steps for performing a competitive pricing analysis is shown. When a buyer has negotiated a new deal, a new interactive pricing analysis template for the new deal may be created (block 402). The interactive pricing analysis template may be provided to the buyer (block 404), and the buyer may provide input at the interactive pricing analysis template describing the details of the negotiated deal (block 406). As described in further detail below, a negotiated deal may involve the purchase of a set of components. The set of components may include one or more components. A component may be a good or a service. Accordingly the details of the negotiated deal may include details describing the set of components of the deal.

The interactive pricing analysis template may then be provided to a competitive pricing analysis firm (block 408). The competitive pricing analysis firm may then evaluate the details of the negotiated deal based on information the firm has describing previously negotiated deals (block 410). As described in further detail below, evaluating the negotiated deal may include determining a best-in-class offer for each component of the deal based on the offers negotiated in one or more previously negotiated deals. In some instances, the best-in-class offer may be a best-in-class price. In other instances, the best-in-class offer may be a best-in-class discount from a list price that is used to determine the best-in-class price. The competitive pricing analysis firm may provide input at the interactive pricing analysis template describing the details of its competitive pricing analysis (block 412).

The interactive pricing analysis template may include a pricing analysis framework. The interactive pricing analysis template may be configured to calculate various scores for the negotiated deal using the pricing analysis framework that are based on the competitive pricing analysis details provided by the competitive pricing analysis firm. The interactive pricing analysis template may, for example, automatically calculate a score for each component of the negotiated deal (block 414) using the pricing analysis framework. The interactive pricing analysis template may also automatically calculate an overall score for the negotiated deal (block 416) using the pricing analysis framework.

The interactive pricing analysis template may also be configured to automatically generate a pricing analysis summary (block 418) that summarizes the pricing aspects of the negotiated deal. As described in further detail below, the pricing analysis summary may include the scores automatically calculated for the negotiated deal and the components of the deal. The interactive pricing analysis template may further be configured to automatically generate an executive summary (block 420) that summarizes multiple aspects of the negotiated deal. Once complete, the interactive pricing analysis template may be provided to the buyer (block 422) for review.

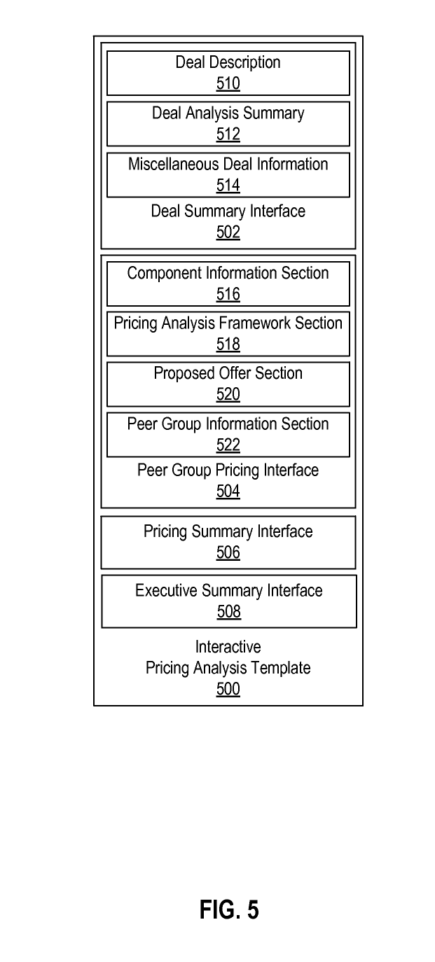

Referring now to FIG. 5, an example of an implementation of an interactive pricing analysis template 500 is shown. An interactive pricing analysis template includes various interfaces for receiving and presenting information associated with the negotiated deal and the competitive pricing analysis performed for the negotiated deal. The interactive pricing analysis template 500, in this example, includes a deal summary interface 502, a peer group pricing interface 504, a pricing summary interface 506, and an executive summary interface.

The interfaces of a pricing analysis template may include input elements that receive information from the buyer regarding the negotiated deal and information from the analysis firm regarding the competitive pricing analysis performed. The deal summary interface 502, in this example, includes: an input element 510 that receives from the buyer information describing the negotiated deal; an input element 512 that receives from the analysis firm information summarizing the results of the competitive pricing analysis; and an input element 514 that receives miscellaneous information pertaining to the deal such as concession opportunities the analysis firm has identified during its evaluation of previously negotiated deals. Other types of miscellaneous deal information that may be included in input element 514 will be appreciated by those skilled in the art of competitive pricing analyses with the benefit of this disclosure. The input elements may be, for example, text fields, textboxes, combo boxes, radio buttons, menus, checkboxes, and other types of user interface elements capable of receiving input from a user.

One or more of the interfaces of an interactive pricing analysis template may include various sections that receive and present information associated with a negotiated deal. The peer group pricing interface 504, in this example, includes: a section 516 that receives and presents information associated with the set of components of the deal; a section 518 that presents information associated with the pricing analysis framework; a section 520 that receives and presents information associated with the proposed offer for the negotiated deal; and a section 522 that receives and presents information associated with the peer groups associated with the previously negotiated deals used to perform the competitive pricing analysis. Each of these interfaces and sections is described in further detail below. It will be appreciated that the interactive pricing analysis template 500 is described by way of example only and that other implementations of a pricing analysis template may include additional and alternative interfaces having additional and alternative input elements and sections.

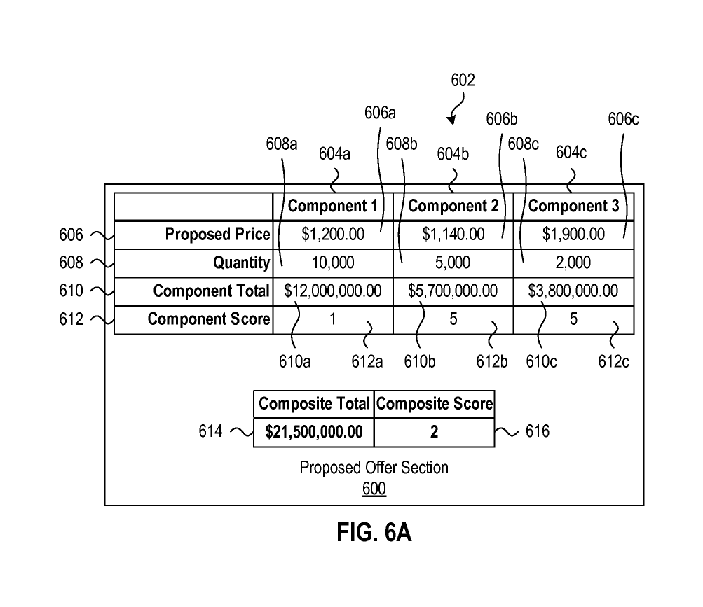

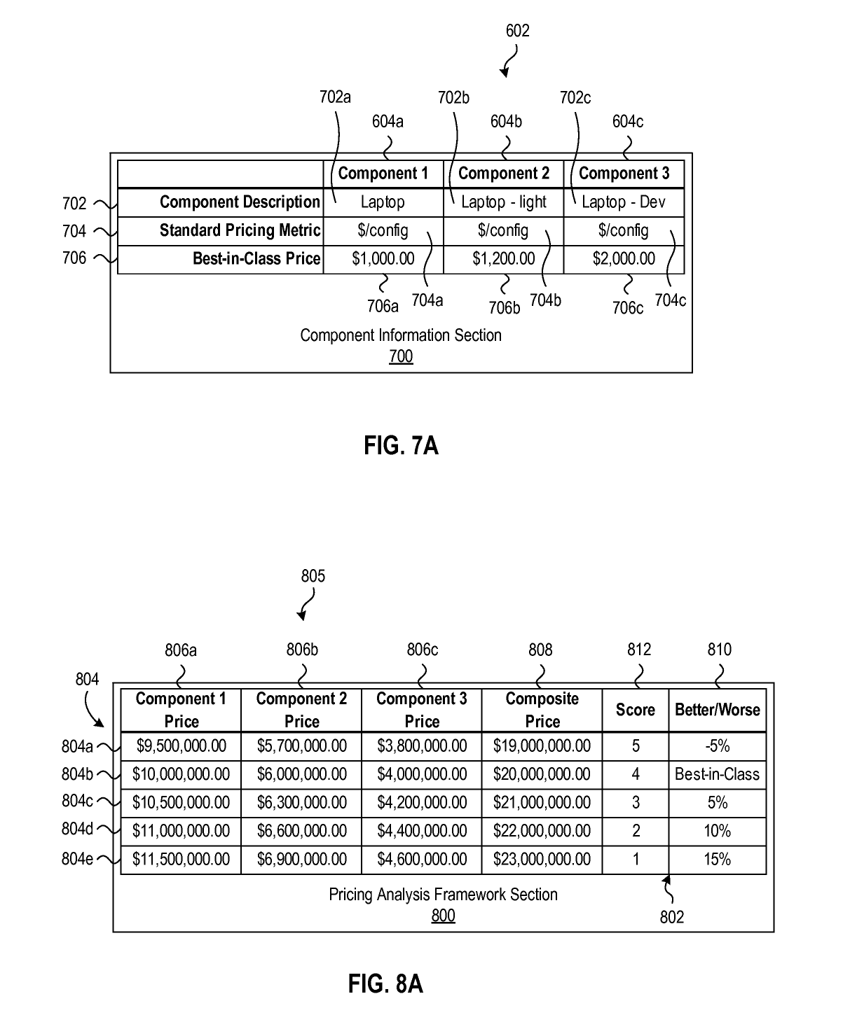

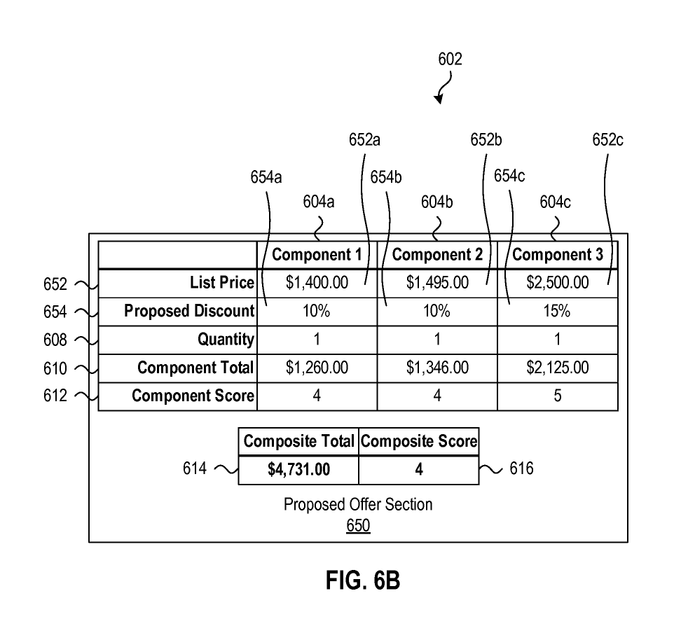

As noted above, a best-in-class offer may be a best-in-class price or may include a best-in-class discount from a list price that is used to determine a best-in-class price. Accordingly the sections described below include examples for each type of best-in-class offer. FIGS. 6A, 7A, and 8A illustrate sections of an interactive pricing analysis template where the best-in-class offer is a best-in-class price. FIGS. 6B, 7B, and 8B illustrate sections of an interactive pricing analysis template where the best-in-class offer is a discount from a list price. As noted above a negotiated deal may involve the purchase of a set of components. A component may be a product or a service, and a set of components may include one or more products, one or more services, or a combination of products and services. The figures described below are described by way of example with reference to a negotiated deal that involves the purchase of three components. Other negotiated deals may involve the purchase or fewer or more components.

Referring to FIG. 6A, an example of an implementation of a proposed offer section 600 of an interactive pricing analysis template is shown where the best-in-class offer is a best-in-class price. The proposed offer section 600 is configured to receive input from the buyer that negotiated the deal. The input received at the proposed offer section 600 describes the offer proposed for each component of the negotiated deal. The proposed offer section, in this example, lists the set 602 of components 604a, 604b, and 604c (collectively components 604) of the negotiated deal. For each component 604, the proposed offer section 600, in this example, identifies a proposed price 606, a quantity 608, a total component price 610, and a component score 612. The total component price 610 for a component 604 is the product of the proposed price 606 and the quantity 608 for that component.

For the first component 604a, the proposed offer section 600 includes: an input element 606a that receives the price proposed for the component in the negotiated deal; an input element 608a that receives the quantity for the component; an interface element 610a that displays the value of total component price for the component at the proposed price and quantity; and an interface element 612a that displays the component score for the component. The proposed offer section 600 may also include, for the second and third components 604b and 604c respectively, similar input elements 606b and 606c that receive the proposed prices and 608b and 608c that receive the component quantities. The proposed offer section 600 may further include, for the second and third components 604b and 604c respectively, similar interface elements 610b and 610c that respectively display the values of total component prices and interface elements 612b and 612c that display the component scores. The total component price 610 is the product of the proposed price 606 and the quantity 608. As described in further detail below, the component score 612 for each component 604 may be based, at least in part, on the total component price 610 and the pricing analysis framework of the interactive pricing analysis template.

The proposed offer section 600, in this example, also includes an interface element that displays a total composite price 614 and an interface element that displays a composite score 616. The total composite price 614 is the sum of the total component prices 610 of the set 602 of components 604. The composite score 616 may represent the overall score for the negotiated deal. As described in further detail below, the composite score 616 is based, at least in part, on the total composite price 614 and the pricing analysis framework.

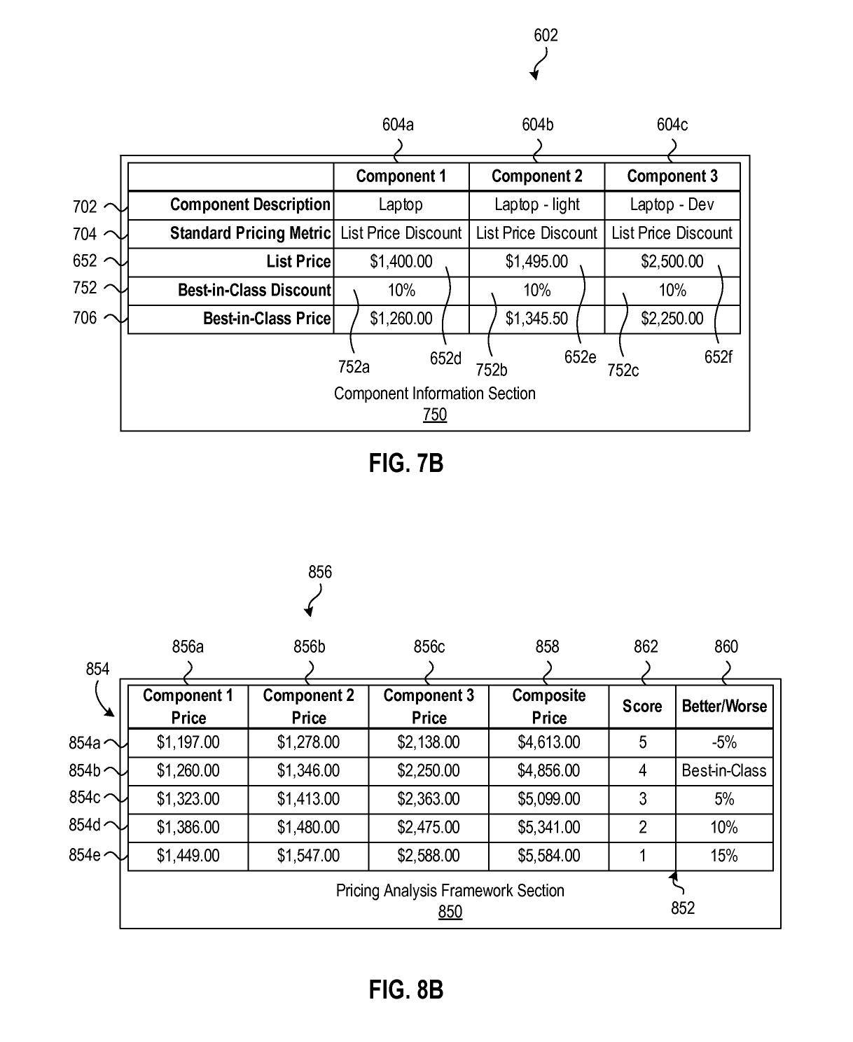

Referring to FIG. 7A, an example of an implementation of a component information section 700 of an interactive pricing analysis template is shown where the best-in-class offer is a best-in-class price. The component information section 700 is configured to receive input from the analysis firm that performs the competitive pricing analysis. The input received at the component information section 700 describes the components of the negotiated deal and the manner in which the analysis firm evaluated the components. The component information section 700, in this example, also lists the set 602 of components 604a, 604b, and 604c of the negotiated deal. For each component 604, the component information section 700, in this example, identifies a component description 702, a standard pricing metric 704, and a best-in-class price 706. The component information section 700, in this example, includes for each component various input elements to receive this information. For the first component, the component information section 700 includes: input element 702a that receives the component description, input element 704a that receives the standard pricing metric, and input element 706a that receives the best-in-class price. The component information section 700 also includes, for the second and third components 604b and 604c respectively, similar input elements 702b and 702c that receive the component description, similar input element 704b and 704c that receive the standard pricing metric, and similar input elements 706b and 706c that receive the best-in-class price.

The analysis firm may provide input corresponding to the component description 702 based on the deal description provided by the buyer (e.g., at input element 510 in FIG. 5). The analysis firm may provide input corresponding to the standard pricing metric 704 based on a list of pricing metrics for various types of components. For some types of products or services, the standard pricing metric may include one or more of a dollar amount or a percentage discount. A table of example types of components and their respective standard pricing metrics appears below. Additional and alternative types of pricing metrics will be appreciated by those skilled in the art of competitive pricing analyses with the benefit of this disclosure.

TABLE 1
EXAMPLE STANDARD PRICING METRICS
FOR EXAMPLE COMPONENTS

| Category | Standard Pricing Metric |
|---|---|
| Mainframe | Price per MIPS |
| Mainframe | List price discount |
| Storage | List price discount |
| Storage | $/TB by Tier |
| Storage | $/TB by drive type |
| Storage | Storage - year to year decline |
| Software | Discount % |
| Software | Price per user |
| Software | Price per license |
| Software | Price per processor |
| Desktop | Price per unit per configuration |
| Desktop | List price discount |
| Desktop | Price per component |
| Laptop | Price per unit per configuration |
| Laptop | List price discount |
| Laptop | Price per component |
| Peripherals/Tablets/Monitors | List price discount |
| Peripherals/Tablets/Monitors | Price per unit per configuration |
| Servers | Discount % per configuration |
| Servers | Year-to-year improvement of |
| | processor power for similar $ |
| Servers | Price per processor |
| Servers | Price per core |
| Software Maintenance | % of net |
| Software Maintenance | % of list |
| Software Maintenance | Price per license |
| Software Maintenance | Price per unit |
| Software Maintenance | Price per user |
| Hardware Maintenance | % of net |
| Hardware Maintenance | % of list |
| Services | Services - $ per hour |
| Services | Services - $ per FTE |

The analysis firm may provide input corresponding to the best-in-class price 706 based on its evaluation of the negotiated deal relative to previously negotiated deals. As described in further detail below, the interactive pricing analysis template may automatically score each component 604 of the negotiated deal based, at least in part, on the best-in-class price 706 and a pricing analysis framework.

Referring now to FIG. 8A, an example of an implementation of a pricing analysis framework section 800 is shown. The pricing analysis framework section 800 includes a pricing analysis framework 802 that is used to score each component 604 of the negotiated deal as well as the negotiated deal itself. The pricing analysis framework 802 includes multiple pricing levels 804. The pricing analysis framework 802 shown by way of example in FIG. 8A includes five pricing levels 804a, 804b, 804c, 804d, and 804e, collectively pricing levels 804. Other example implementations may include more or fewer pricing levels. As seen in FIG. 8A, each pricing level 804 includes a set 805 of individual comparison prices, a composite comparison price 808, a percentage multiplier 810, and a pricing score 812. The composite price 808 for a pricing level 804 is the sum of the set 805 of comparison prices 806 for that pricing level.

The set 602 of components 604, in this example, includes three components 604a-c. Accordingly the each pricing level 804 of the pricing analysis framework 802, in this example, includes three comparison prices 806a, 806b, 806c (collectively comparison prices 806). Each comparison price 806 of a pricing level 804 corresponds to one of the components 604: comparison prices 806a correspond to component 604a; comparison prices 806b correspond to component 604b; and comparison prices 806c correspond to component 604c.

The value of a comparison price 806 at each pricing level 804 is based on the value of the best-in-class price 706 for the corresponding component 604, the value of the quantity 608 for the corresponding component, and the value of the percentage multiplier 810 for that pricing level.

More specifically, the value of a comparison price 806 may be:

CP=[BIC+(BIC×PM)]×Qty

where CP is the comparison price 806 for the corresponding component 604, BIC is the best-in-class price 706 for the corresponding component, Qty is the quantity for the corresponding component, and PM is the percentage multiplier 810 for the pricing level 804. The percentage multiplier 810 for a pricing level 804 may be a positive percentage multiplier or a negative percentage multiplier used to assess whether the proposed offer is relatively better or worse than the best-in-class offer, i.e., whether the proposed offer is x % above or below than the best-in-class offer.

A pricing analysis framework may include at least one pricing level that corresponds to the best-in-class price which serves as a benchmark to compare the proposed price against. The pricing level 804b pricing analysis framework 802, in this example, corresponds to the best-in-class price for the components 604. A pricing analysis framework may include at least one pricing level having a negative percentage multiplier representing a proposed offer that is relatively better than the best-in-class offer and at least one pricing level having a positive percentage multiplier representing a proposed offer that is relatively worse than the best-in-class offer. The percentage multiplier may range between about 1% and about 99%. The pricing levels 804 of the pricing analysis framework 802, in this example, includes one pricing level 804a below the best-in-class price and three pricing levels 804c, 804d, and 804e above the best-in-class price. The percentage multipliers 810, in this example, include a −5% percentage multiplier for pricing level 804a, a +5% percentage multiplier for pricing level 804c, a +10% percentage multiplier for pricing level 804d, and a +15% percentage multiplier for pricing level 804e. Other implementations may include pricing levels with alternative percentage multipliers. The pricing levels and the percentage multipliers may be fixed or user-configurable. A pricing analysis template may be configured, for example, to receive input from a user that adds additional pricing levels and input that specifies the percentage multiplier for a pricing level.

As noted above, a component score 612 may be automatically determined for each component 604 based on the total component price 610 and the pricing analysis framework 802. The total component price 610 for a component 604 is compared to the comparison prices 806 of the pricing levels 804 of the pricing analysis framework 802. A pricing analysis template, such as interactive pricing analysis template 500, is configured to identify the first pricing level 804 of the pricing analysis framework 802 at which the total component price 610 is at or below the comparison price 806. If the total component price 610 exceeds the highest comparison price 806, then the component may receive the pricing score 812 of the pricing level 804 having the highest component price. For example, the total component price 610 for the first component 604a, in this example, is $12 M, which exceeds the highest comparison price 806a for the first component at the pricing analysis framework 802 (i.e., $11.5 M) which is 15% higher than the best-in-class price for this component. Accordingly the component score 612a for the first component 604a, in this example, is the pricing score 812 associated with the pricing level 804e, i.e. a score of 1, the lowest score. The total component price 610 for the second and third components, in this example, equal the lowest comparison prices 806b and 806c for the second and third components at the pricing analysis framework (i.e., $5.7 M and $3.8 M) which are 5% lower than the best-in-class price for these components. Accordingly the component scores 612b and 612c for the second and third components 604b and 604c, in this example, is the pricing score 812 associated with the pricing level 804a, i.e., a score of 5, the highest score.

A pricing analysis template, such as interactive pricing analysis template 500, may be configured to similarly determine the composite score 616 for the negotiated deal. The composite score 616 is based on the total composite price 614 and the composite comparison price 808 of the pricing analysis framework 802. The interactive pricing analysis template 500 identifies the first pricing level 804 of the pricing analysis framework 802 at which the total composite price 614 is at or below the composite comparison price 808. For example, the total composite price 614 for the set 602 of components 604 is $21.5 M, which exceeds the composite comparison price 808 of the pricing level 804c (i.e., $21 M) but is below the composite price of the pricing level 804d (i.e., $22 M). Accordingly the composite score 616 for the components 604 is the pricing score 812 associated with the pricing level 804d, i.e., a score of 2, which corresponds to a composite comparison price 808 that is 10% higher than the best-in-class price.

Referring to FIG. 6B, another example of an implementation of a proposed offer section 650 of an interactive pricing analysis template is shown. In this example, the best-in-class offer is a discount from a list price. The proposed offer section 650 is likewise configured to receive input from the buyer that negotiated the deal. The input received at the proposed offer section 650 describes the offer proposed for each component of the negotiated deal. As seen in FIG. 6B, the proposed offer section 650 includes, for each component 604, a list price 652 and a proposed discount 654 in addition to a quantity 608, total component price 610, component score 612, total composite price 614, and composite score 616. Accordingly the total component price 610 for each component 604, in this example, is based on the list price 652 and the proposed discount 654. For example, the total component price 610 for the first and second components 604a and 604b is 10% and the total component price for the third component 604c is 15% less than the corresponding list prices 652. The total composite price 614, in this example, is likewise the sum of the total component prices 610 of the set 602 of components 604. The component scores 612 for each component and the composite score 616 for the negotiated deal, in this example, are also based on the pricing analysis framework.

The proposed offer section 650, in this example, includes interface elements 652a, 652b, and 652c that respectively receive the list prices 652 for the components 604a, 604b, and 604c. The proposed offer section 650, in this example, also includes interface elements 654a, 654b, and 654c that receive the respective proposed discounts 654 for the components 604a, 604b, and 604c. The proposed offer section 650 further includes interface elements as described above that respectively receive the quantity 608 for each of the components 604 and display the total component price 610 and component score for each of the components as described above with reference to FIG. 6A.

Referring now to FIG. 7B, another example of a component information section 750 is shown where the best-in-class offer is a discount from a list price. The component information section 750 is likewise configured to receive input from the analysis firm that performs the competitive pricing analysis, and the input received at the component information section describes the negotiated deal and the manner in which the analysis firm evaluated the components. The component information section 750 likewise identifies a component description 702, standard pricing metric 704, and best-in-class price 706 for each component 604 in the set 602 of components as described above with reference to FIG. 7A. The component information section 750, in this example, also identifies a list price 652 and best-in-class discount 752 for each component 604 in the set 602 of components. The best-in-class price 706 for each component is thus based on the list price 652 and the best-in-class discount 752 for that component.

The component information section 750, in this example, likewise includes for each component various interface elements to display and receive the component information. The interface elements include elements 652d, 652e, and 652f that display the list price 652 for the respective components 604a, 604b, and 604c as well as input elements 752a, 752b, and 752c that receive the best-in-class discount 752 for the respective components. The analysis firm may provide input corresponding to the best-in-class discount 752 for the components 604 which is in turn utilized to determine the best-in-class price 706 for each component.

Referring now to FIG. 8B, another example of a pricing analysis framework section 850 having another example of a pricing analysis framework 852 is shown. The pricing analysis framework 852 is likewise used to score the components 604 of the negotiated deal and the negotiated deal itself. Similar to the pricing analysis framework 802 of FIG. 8A, the pricing analysis framework 852 includes multiple pricing levels 854. Each pricing level 854 similarly includes: a component price 856 for each component 604 in the set 602 of components; a composite price 858 that is the sum of the component prices; a percentage multiplier 860; and a score 862. The pricing analysis framework 852, in this example, likewise includes one pricing level 854b corresponding to the best-in-class offer, one pricing level 854a having a percentage multiplier below the best-in-class offer, and three pricing levels 854c, 854d, and 854e having respective percentage multipliers above the best-in-class offer. The pricing analysis framework 852 may be similarly utilized to determine a component score 612 for each component of the negotiated deal as well as a composite score 616 for the negotiated deal as described above.

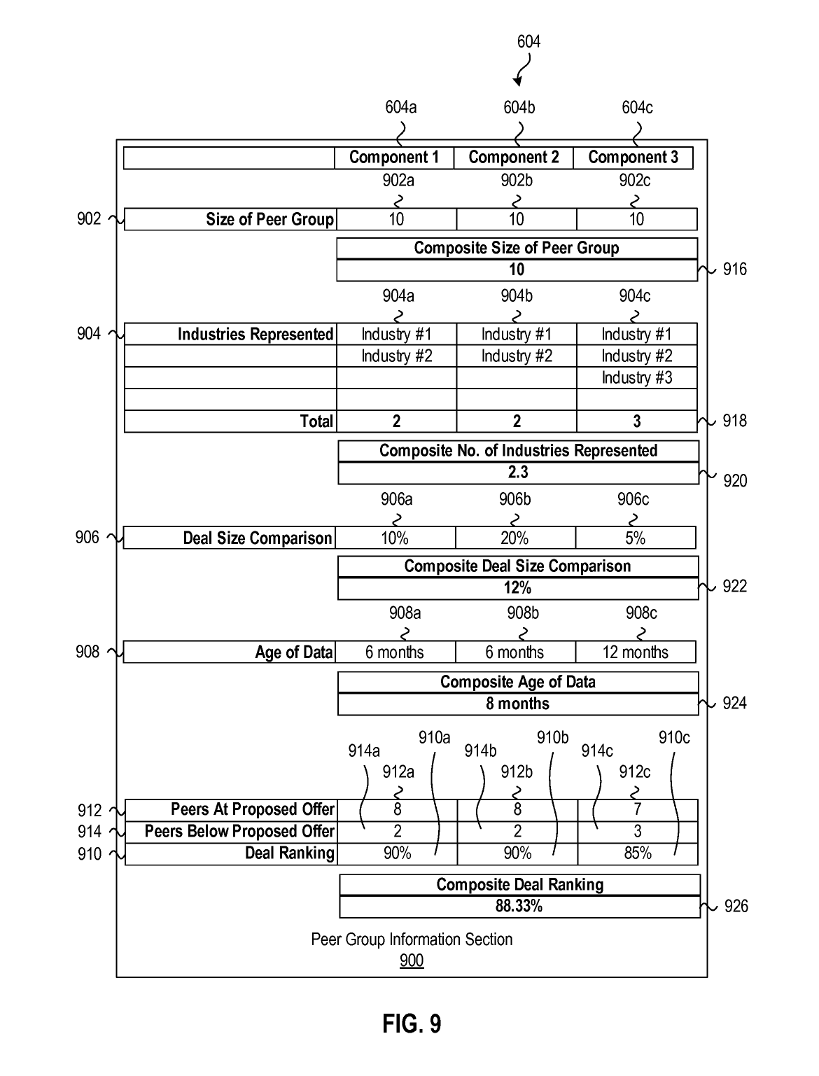

Referring now to FIG. 9, an example of an implementation of a peer group information section 900 is shown. The peer group information section 900 is configured to receive and display information associated with the peer groups that negotiated previous deals the analysis firm uses to perform the competitive pricing analysis. In this way, a buyer may advantageously utilize the pricing analysis template to assess the validity of the competitive pricing analysis performed. It will be appreciated, for example, the validity of a competitive pricing analysis may depend on the age of the data and the number of peer groups used to perform the competitive pricing analysis. A competitive pricing analysis that is based on relatively more recent data may be more valid that a competitive pricing analysis that is based on relatively less recent data. Likewise a competitive pricing analysis based on deals previously negotiated by relatively more peer groups may be more valid than a competitive pricing analysis that is based on relatively fewer peer groups.

The peer group information section 900, in this example includes for each component 604 in the set 602 of components input elements that receive input corresponding to: a peer group size 902 used to perform the competitive pricing analysis; a list of the industries 904 represented by the peer groups; a deal size comparison 906 between the negotiated deal and the previously negotiated deals; an age of the data 908 used to perform the competitive pricing analysis; and a deal ranking 910 that is based on the total number of peers 912 at or above the proposed offer and the total number of peers 914 below the proposed offer. The deal ranking 910 may be, for example, a deal ranking percentile.

The peer group information section 900, in this example, includes input elements 902a, 902b, and 902c that receive input corresponding to the number of peer groups used to perform the competitive pricing analysis for each component 604. The peer group information section 900 also includes an interface element that displays a composite peer group size 916 which may be the average of each peer group size 902. For some competitive pricing analyses, some buyers may prefer the composite size of the peer group 916 to be around ten.

The peer group information section 900, in this example, includes input elements 904a, 904b, and 904c that receive input corresponding to a list of industries represented by the peer groups for each of the components 604. The peer group information section 900, in this example, also includes interface elements that display the total number of industries 918 in each list of industries as well as an interface element that displays the composite number of industries represented 920. The composite number of industries represented 920 may be the average of the total number of industries 918 in each list. For some competitive analyses, a buyer may prefer the analysis firm to perform the competitive pricing analysis based on deals negotiated in multiple industries including the industry the buyer belongs to as well as other industries. Accordingly a buyer may prefer the composite number of industries represented 920 to be at least two. In this way, the buyer may determine whether buyers in other industries are able to negotiate relatively better deals.

A table of example industries appears below. Additional and alternative types of industries will be appreciated by those skilled in the art of competitive pricing analyses with the benefit of this disclosure.

TABLE 2
EXAMPLE INDUSTRIES FOR PEER GROUPS
Industry

Agriculture, Forestry, Fishing and Hunting
Mining, Quarrying, and Oil and Gas Extraction
Utilities
Construction
Manufacturing
Wholesale Trade
Retail Trade
Transportation and Warehousing
Information
Finance and Insurance
Real Estate and Rental and Leasing
Professional, Scientific, and Technical Services
Management of Companies and Enterprises
Administrative and Support and Waste Management
and Remediation Services
Educational Services
Health Care and Social Assistance
Arts, Entertainment, and Recreation
Accommodation and Food Services
Other Services (except Public Administration)
Public Administration

The peer group information section 900, in this example, includes input elements 906a, 906b, and 906c that receive input corresponding to a comparison of the size of the negotiated deal for each component 604 relative to the previously negotiated deals. The peer group information section 900 also includes an interface element that displays a composite deal size comparison 922 which may be the average of each deal size comparison 906. In some example implementations, the deal size comparison may be a deal size percentage. For some competitive pricing analyses, a buyer may prefer the composite deal size comparison to be a deal size percentage of at least 10%.

The peer group information section 900, in this example, includes input elements 908a, 908b, and 908c that receive input corresponding to the age of the data used to perform the competitive pricing analysis. The peer group information section 900 also includes an interface element that displays a composite age of the data 924 which may be the average of each age of the data 908. For some competitive pricing analyses, a buyer may prefer the composite age of the data 924 to be no more than twelve months old.

The peer group information section 900, in this example includes input elements 912a, 912b, and 912c that receive input corresponding to the number of peer groups that have previously negotiated deals at or above the offer proposed for the respective components 604 of the negotiated deal. The peer group information section 900 also includes input elements 914a, 914b, and 914c that receive input corresponding to the number of peer groups that have previously negotiated deals below the offer proposed for the respective components 604 of the negotiated deal. The peer group information section 900 may additionally include interface elements 910a, 910b, and 910c that displays a deal ranking for each of the components 604 of the negotiated deal. The deal ranking 910 may be a percentage and determined using the example equation below:

$$DR = ( {P}_{a} \times \frac{1}{2} {P}_{b} ) \div N$$

where DR is a percentile that represents the deal ranking 910, Pₐ is the number of peers at or above the currently negotiated deal, P_{b} is number of peers below the currently negotiated deal, and N is the total number of peers. A deal ranking at the x^{th} percentile may indicate the deal currently negotiated by the buyer is in the top (100−x) percent of previously deals. For example, a deal ranking of 90% may indicate that the deal currently negotiated by the buyer is in the top 10% of the previously negotiated deals. The peer group information section 900 may further include an interface element that display a composite deal ranking 926 for the negotiated deal which may be the average of each deal ranking 910. For some competitive analyses, a buyer may prefer that the negotiated deal is in the top 10% of previously negotiated deals.

It will be appreciated that, in some example implementations, the peer group information section may include interface elements for receiving and displaying additional and alternative information associated with the peer groups that negotiated the previous deals used to perform the competitive pricing analysis.

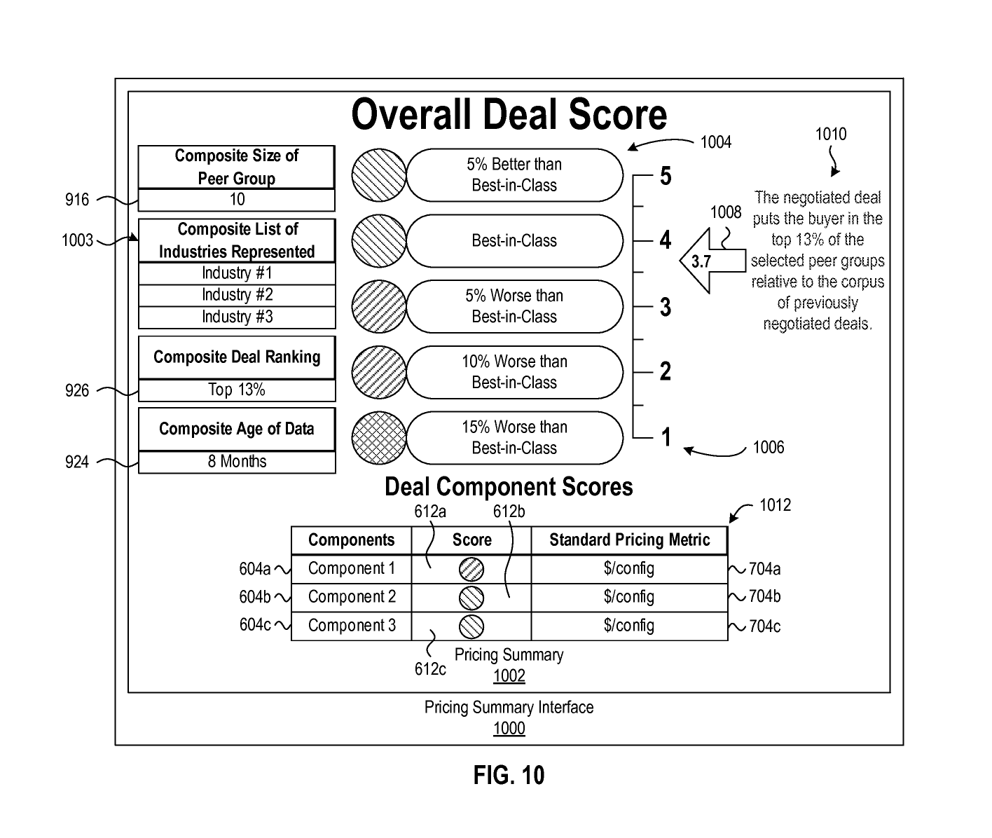

Referring now to FIG. 10 an example of an implementation of a pricing summary interface 1000 of an interactive pricing analysis template is shown. The pricing analysis template may automatically create and configure the pricing summary based on the input received from the buyer and the analysis firm at the deal summary interface and the peer group pricing interface described above. The pricing summary interface 1000 includes a pricing summary 1002 that summarizes the results of the competitive pricing analysis. The pricing summary 1002, in this example, includes the composite peer group size 916, the composite deal ranking 926, the composite age of the data 924 used to perform the competitive pricing analysis, and a composite list of industries 1003 associated with the peer groups. The pricing summary 1002 also includes a graphical representation 1004 that graphically depicts the pricing levels of the pricing analysis framework. Each pricing level may be color-coded (e.g., green, yellow, and red) at the pricing summary 1002. The pricing summary 1002 also includes a scale 1006 with a corresponding graphical indicator 1008 that indicates the overall score for the negotiated deal. The pricing summary 1002 also includes a textual indicator 1010 that may present the deal analysis summary received from the analysis firm at the input element 512 described above with reference to FIG. 5. As also seen in FIG. 10, the pricing summary 1002 includes a component listing 1012 of each component 604 of the negotiated deal. The component listing 1012 may include, for each component, the corresponding standard pricing metric 704 and the corresponding component score 612. The component score 612 may be color-coded to correspond to the graphical representation 1004 of the pricing level. Other implementations of the pricing summary interface 1000 may include additional or alternative information associated with the results of the competitive pricing analysis.

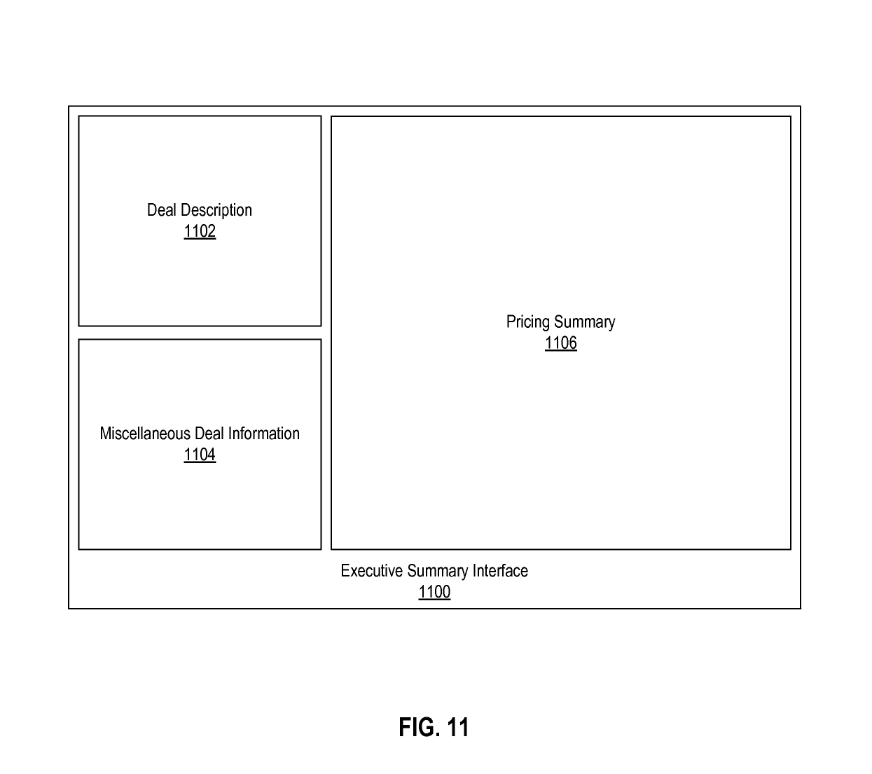

Referring to FIG. 11, an example of an implementation of an executive summary interface 1100 of an interactive pricing analysis template is shown. As seen in FIG. 11, the executive summary interface 1100, in this example, includes an interface element 1102 that presents the deal description for the negotiated deal, an interface element 1104 that present the miscellaneous deal information for the negotiated deal, and a pricing summary 1106 for the negotiated deal. The interface element 1102 may present the deal description received at the input element 510 described above with reference to FIG. 5. The interface element 1104 may present the miscellaneous deal information received at the input element 514 described above with reference to FIG. 5. The pricing summary 1106 may be the same as or at least similar to the pricing summary 1002 described above with reference to FIG. 10.

The interactive pricing analysis template may be configured to provide the pricing summary 1106 and the executive summary interface 1100 in a portable electronic format such as an electronic image (e.g., a GIF image, a JPG image, and the like) or electronic document (e.g., a DOC file, PDF file, and the like). In this way, the buyer may advantageously transmit the pricing summary of the executive summary to other individuals or include them in a presentation. Additional uses for the pricing summary and executive summary will be appreciated with the benefit of this disclosure.

The foregoing descriptions of the disclosure have been presented for purposes of illustration and description. They are not exhaustive and do not limit the disclosure to the precise form disclosed. Modifications and variations are possible in light of the above teachings or may be acquired from practicing of the disclosure. The described implementation includes software but may be implemented as a combination of hardware and software or in hardware alone. Additionally, although aspects of the present disclosure are described as being stored in memory, one skilled in the art will appreciate that these aspects can also be stored on other types of computer-readable media, such as secondary storage devices, like hard disks, floppy disks, CD-ROM discs, flash memory sticks, and so forth.

What is claimed is:

1. A system for competitive pricing analysis comprising:
a display device;
a processing unit in signal communication with the display device; and
memory in signal communication with the processing unit wherein the memory stores computer-readable instructions that, when executed by the processing unit, cause the system to
i) present an interactive pricing analysis template at the display device,
ii) receive information describing a negotiated deal at the at the interactive pricing analysis template wherein the negotiated deal involves an offer to purchase a set of components,
iii) automatically calculate, for each component in the set of components, a component score based, at least in part, on a best-in-class offer for the component and a pricing analysis framework, and
iv) automatically calculate a composite score for the negotiated deal based, at least in part, on a pricing analysis framework;
wherein the interactive pricing analysis template comprises, for each component in the set of components,
a first input element that receives a standard pricing metric for the component,
a second input element that receives the best-in-class offer for the component,
a third input element that receives a proposed offer for the component, and
a fourth input element that receives a quantity for the component.

2. The system of claim 1 wherein:
the instructions, when executed by the processing unit, further cause the system to
v) automatically calculate, for each component in the set of components, a total component price based on the proposed offer and the quantity for the component, and
vi) automatically calculate a total composite price for the negotiated deal based on each total component price;
the component score, for each component in the set of components, is further based on the total component price for the component; and
the composite score is further based on the total composite price.

3. The system of claim 2 wherein:
the pricing analysis framework comprises a plurality of pricing levels;
each pricing level in the plurality of pricing level comprises
a percentage multiplier,
a pricing score,
a comparison price for each component in the set of components, and
a composite comparison price;
the comparison price is based on the best-in-class offer for the component, the quantity for the component, and the percentage multiplier; and
the composite comparison price is based on each comparison price.

4. The system of claim 3 wherein:
the pricing analysis framework includes at least one pricing level wherein the percentage multiplier is a positive percentage multiplier; and
the pricing analysis framework includes at least one pricing level wherein the percentage multiplier is a negative percentage multiplier.

5. The system of claim 4 wherein:
the pricing analysis framework comprises
a first pricing level wherein the percentage multiplier is −5%,
a second pricing level wherein the percentage multiplier is +5%,
a third pricing level wherein the percentage multiplier is +10%, and
a fourth pricing level wherein the percentage multiplier is +15%.

6. The system of claim 1 wherein:
the standard pricing metric comprises a dollar amount;
the best-in-class offer comprises a best-in-class price; and
the proposed offer is a proposed price.

7. The system of claim 1 wherein:
the standard pricing metric comprises a list price discount;
the best-in-class offer comprises a list price, a percentage discount, and a best-in-class price; and
the proposed offer is a proposed discount.

8. The system of claim 1 wherein:
the interactive pricing analysis template further comprises at least one additional input element, associated with at least one of the components in the set of components, that receives information associated with one or more previously negotiated deals used to determine the best-in-class offer for the component.

9. The system of claim 8 wherein:
the at least one additional input element comprises, for each component in the set of components,
a fifth input element that receives a peer group size corresponding to a total number of peers used to determine the best-in-class offer for the component,
a sixth input element that receives a list of one or more industries from which the peers were selected,
a seventh input element that receives a deal size percentage that indicates the size of the negotiated deal relative to the one or more previously negotiated deals, and
an eighth input element that receives an age of the information associated with the one or more previously negotiated deals.

10. The system of claim 8 wherein:
the at least one additional input element comprises, for each component in the set of components,
a fifth input element that receives a first total number of peers associated with a previously negotiated deal determined to be better than the negotiated deal, and
a sixth input element that receives a second total number of peers associated with a previously negotiated deal determined to be worse than the negotiated deal,
wherein the determination is based on a comparison of the best-in-class offer for the component of the negotiated deal and one or more previously negotiated offers associated with the one or more previously negotiated deals; and
the instructions, when executed by the processing unit, further cause the system to
v) automatically calculate, for each component in the set of components, a ranking percentile for the negotiated deal based on the first total number of peers and the second total number of peers.

11. A computer-implemented method for competitive pricing analysis comprising:
presenting, to a first user at a first display device, an interactive pricing analysis template;
receiving, from the first user at the interactive pricing analysis template, information describing a negotiated deal that involves an offer to purchase a set of components;
presenting, to a second user at a second display device, the interactive pricing analysis template;
receiving, from the second user at the interactive pricing analysis template, for each component in the set of components, a standard pricing metric for the component and a best-in-class offer for the component;
automatically calculating, for each component in the set of components, a component score based, at least in part, on the best-in-class offer for the component and a pricing analysis framework; and
automatically calculating a composite score for the negotiated deal based, at least in part, on the pricing analysis framework
wherein the interactive pricing analysis template comprises, for each component in the set of components,
a first input element that receives the standard pricing metric for the component,
a second input element that receives the best-in-class offer for the component,
a third input element that receives a proposed offer for the component, and
a fourth input element that receives a quantity for the component.

12. The method of claim 11 further comprising:
automatically calculating, for each component in the set of components, a total component price based on the proposed offer and the quantity for the component;
automatically calculating a total composite price for the negotiated deal based on each total component price;
wherein the component score, for each component in the set of components, is further based on the total component price for the component; and
wherein the composite score is further based on the total composite price.

13. The method of claim 12 wherein:
the pricing analysis framework comprises a plurality of pricing levels;
each pricing level in the plurality of pricing levels comprises
a percentage multiplier,
a pricing score,
a comparison price for each component in the set of components, and
a composite comparison price;
the comparison price is based on the best-in-class offer for the component, the quantity for the component, and the percentage multiplier; and
the composite comparison price is based on each comparison price.

14. The method of claim 13 wherein:
the pricing analysis framework includes at least one pricing level wherein the percentage multiplier is a positive percentage multiplier; and
the pricing analysis framework includes at least one pricing level wherein the percentage multiplier is a negative percentage multiplier.

15. The method of claim 14 wherein:
the pricing analysis framework comprises
a first pricing level wherein the percentage multiplier is −5%,
a second pricing level wherein the percentage multiplier is +5%,
a third pricing level wherein the percentage multiplier is +10%, and
a fourth pricing level wherein the percentage multiplier is +15%.

16. The method of claim 11 wherein:
the standard pricing metric comprises a dollar amount;
the best-in-class offer comprises a best-in-class price; and
the proposed offer is a proposed price.

17. The method of claim 11 wherein:
the standard pricing metric comprises a list price discount;
the best-in-class offer comprises a list price, a percentage discount, and a best-in-class price; and
the proposed offer is a proposed discount.

18. The method of claim 11 wherein:
the interactive pricing analysis template further comprises at least one additional input element, associated with at least one of the components in the set of components, that receives information associated with one or more previously negotiated deals used to determine the best-in-class offer for the component.

19. The method of claim 18 wherein:
the at least one additional input element comprises, for each component in the set of components,
a fifth input element that receives a peer group size corresponding to a total number of peers used to determine the best-in-class offer for the component,
a sixth input element that receives a list of one or more industries from which the peers were selected,
a seventh input element that receives a deal size percentage that indicates the size of the negotiated deal relative to the one or more previously negotiated deals, and
an eighth input element that receives an age of the information associated with the one or more previously negotiated deals.

20. The method of claim 18 further comprising:
automatically calculate, for each component in the set of components, a ranking percentile for the negotiated deal;
wherein the at least one additional input element comprises, for each component in the set of components,
a fifth input element that receives a first total number of peers associated with a previously negotiated deal determined to be better than the negotiated deal, and
a sixth input element that receives a second total number of peers associated with a previously negotiated deal determined to be worse than the negotiated deal,
wherein the determination is based on a comparison of the best-in-class offer for the component of the negotiated deal and one or more previously negotiated offers associated with the one or more previously negotiated deals; and
wherein the ranking percentile is based on the first total number of peers and the second total number of peers.
